(19) United States
(12) Patent Application Publication
(10) Pub. No.: US 2002/0047755 A1
(43) Pub. Date: Apr. 25, 2002

(54) POWER DISTRIBUTION/SYNTHESIS APPARATUS

(76) Inventors: SATORU SUGAWARA, TOKYO (JP); KOJI MIZUNO, SENDAI-SHI (JP)

Correspondence Address: OBLON SPIVAK MCLCLEKKAND, MAIER & NEUSTADT P C, FOURTH FLOOR, 1755 JEFFERSON DAVIS HIGHWAY, ARLINGTON, VA, 22202

(21) Appl. No.: 09/452,693

(22) Filed: Dec. 3, 1999

(30) Foreign Application Priority Data
Dec. 9, 1998 (JP) 10-366060

(51) Int. Cl. H01P 5/12

(52) U.S. Cl. 333/127

(57) ABSTRACT

In a power distribution/synthesis apparatus, two quarter wavelength lines are connected to a first I/O terminal. A first transmission line is connected between the other end of one of the quarter wavelength lines and one of the second I/O terminals, a second transmission line is connected between the other end of the remaining quarter wavelength line and the remaining second I/O terminal, a third transmission line is connected between an absorption resistor and the one of the second I/O terminals, and a forth transmission line is connected between the absorption resistor and the remaining second I/O terminal. Assuming that the characteristic impedance at the I/O terminals is Z0, the characteristic impedance of each of the four transmission lines is set to √2·Z0.

### FIELD OF THE INVENTION

The present invention relates to a power distribution/synthesis apparatus applicable to communication equipment, measurement equipment, and some other equipment with a high-frequency circuit incorporated therein. More particularly, this invention relates to a power distribution/synthesis apparatus used mainly in a band from a quasi-millimeter wave to a millimeter wave and a submillimeter wave.

### BACKGROUND OF THE INVENTION

As an example of a conventional type of power distribution/synthesis apparatus, there is the one shown in FIG. 6. In this figure, designated at the reference numerals 1, 2, and 3 are I/O terminals, at 4 a branch section, at a an absorption resistor, and at b a quarter wavelength line.

Two quarter wavelength lines b are connected to the I/O terminal 1 via the branch section 4, and the other ends of the quarter wavelength lines are connected to the I/O terminals 2 and 3 respectively. The I/O terminal 2 and the I/O terminal 3 are connected to each other through the absorption resistor a.

Operations of this apparatus are explained below. A signal supplied from the I/O terminal 1 is branched into the two quarter wavelength lines b in a uniform amplitude, and the branched signals are fetched from the I/O terminal 2 and the I/O terminal 3. Each of the quarter wavelength lines b operates as an impedance converter and matches a characteristic impedance Z0 of the I/O terminal 1 to that of each external circuit connected to the I/O terminal 2 and I/O terminal 3. The absorption resistor a absorbs unbalanced components of the I/O terminals 2 and 3 to provide isolation between the I/O terminal 2 and the I/O terminal 3.

FIG. 7A and FIG. 7B show a parameter S when a design frequency in the power distribution/synthesis apparatus shown in FIG. 6 is set to 25 GHz. FIG. 7A is shown in dB, and FIG. 7B shows a Smith chart. As shown in this figure, all of the amount of reflection S11 and S22 from each of the I/O terminals and the isolation S23 between the I/O terminal 2 and the I/O terminal 3 are zero at the design frequency of 25 GHz, which shows that a complete matching and isolation is achieved therebetween. In this figure, lines S11 and S23 are seen as one line, but in fact are there are two separate lines that are superimposed on each other each representing S11 and S23. The above explanation is for a case where power is distributed using this power distribution/synthesis apparatus. However, when power is to be synthesized, a flow of signal is only in the opposite direction because a plurality of inputs are synthesized into one output. Accordingly, only the I/O terminals are replaced with each other and the other components in the circuit configuration are the same as those in FIG. 6, in which the relation between impedances or the like holds as it is. Therefore, only a case of power distribution is described below, and description of a case of power synthesis will be omitted.

Conventionally, since the frequency used in a power distribution/synthesis apparatus was not so high. Therefore, the main technical object was how to minimize the size of the overall circuit. In recent years, however, an operational frequency of a high-frequency circuit has been shifted from a microwave band to a millimeter wave band or a submillimeter wave band due to exhaustion of frequency resources as well as due to enhancement in performance of active elements in a semiconductor. In association with this tendency, length of the quarter wavelength line became as short as around 1 mm or less than that. Therefore, presently the problem of size of the power distribution/synthesis apparatus itself is not so big as it used to be earlier.

Further, an absorption resistor has been considered as a lumped constant element in principle, so that a physical size of the resistor was not much considered. However, to assume that the absorption resistor is a lumped constant element, the size of the absorption resistor has to be made smaller according to miniaturization of the power distribution/synthesis apparatus. However, when the size of the absorption resistor is made smaller, a space between lines of the I/O terminals linked to each other via the absorption resistor becomes narrow, which causes design rules to be restricted and unnecessary increases the crosstalk.

On the other hand, in order to suppress crosstalk, for example, the power distribution/synthesis apparatus in FIG. 8 can be used. FIG. 8 shows configuration of the power distribution/synthesis apparatus which suppresses crosstalk by providing lines c each between the absorption resistor a and each of quarter wavelength lines b. In this figure, the reference numerals 1 to 3 indicate I/O terminals, and the reference numeral 4 indicates a branch section.

FIG. 9 shows Parameters S when the line c whose power length is 20 degrees assuming that a design frequency in the power distribution/synthesis apparatus in FIG. 8 is 25 GHz. FIG. 9A is shown in dB and FIG. 9B shows a Smith chart. In this figure, lines S11 and S23 are seen as one line, but in fact there are two separate lines that are superimposed on each other each representing S11 and S23.

As shown in this figure, the isolation S23 between the I/O terminal 2 and the I/O terminal 3 is as high as −18.2 dB at the design frequency of 25 GHz. As described above, the power distribution/synthesis apparatus in FIG. 8 can suppress crosstalk, but the isolation between the I/O terminal 2 and the I/O terminal 3 becomes extremely worse.

As a basic transmission line especially for a high-frequency circuit such as an MMIC, an easily-designable micro-strip line was mainly been used. However, in recent years, the mainstream has shifted to a CPW which can be easily connected to a semiconductor device. Although the CPW has the characteristic of easy connectability to the semiconductor device because a signal line and a grounded conductor are located on one plane, its layout is complicated. Namely, an air bridge is required for a discontinuous section, and flexibility in the layout is significantly reduced as compared to that of the micro-strip line when a space between the lines described above is made extremely narrow.

As described above, in the Wilkinson type of power distribution/synthesis apparatus based on the conventional technology, a size of an absorption resistor has to be made smaller so that it is more negligible as compared to a wavelength of a design frequency. Therefore, there is a problem that flexibility in the layout or isolation between I/O terminals connected to each other via the absorption resistor is reduced. The problem described above becomes more obvious especially in the CPW which is popular in recent years.

### SUMMARY OF THE INVENTION

It is an object of the present invention to provide a Wilkinson type of power distribution/synthesis apparatus with a high degree of flexibility in its layout and a high degree of isolation between I/O terminals connected to each other via an absorption resistor.

In the present invention, a transmission line with a length L having the characteristic impedance of √2·Z0 is provided between an absorption resistor and each of second I/O terminals and further between each of quarter wavelength lines and the second I/O terminal corresponding to the quarter wavelength line. Therefore, it is possible to provide a sufficient space between the I/O terminals with isolation therebetween via the absorption resistor kept at high level. As a result, a power distribution/synthesis apparatus in which a crosstalk does not occur and the degree of flexibility in its layout is high can be obtained.

Further, the length L of the transmission line is set to a half wavelength or an integral multiple of the half wavelength. Accordingly, a characteristic impedance of this newly added transmission line is equivalent to that of a quarter wavelength line. Therefore, and matching among all of the components is completely achieved so that the possibility of occurrence of unnecessary reflection is eliminated. Although complete matching is performed based on a design wavelength, there is the tendency that a frequency band width becomes narrower as the length of the connected transmission line increases. To overcome this problem, it is preferable that the transmission line to be connected is a half wavelength. As a result, a power distribution/synthesis apparatus in which matching of the all the components can completely be achieved, crosstalk does not occur and the degree of flexibility in its layout is high can be obtained.

Further, the circuit is formed with a CPW. Therefore, the space required for provision of an air bridge or the like, in other words, a space between I/O terminals connected to each other via an absorption resistor can be insured. As a result, a power distribution/synthesis apparatus in which a crosstalk does not occur, the degree of flexibility in its layout is high and can easily be connected to a semiconductor device can be obtained.

Other objects and features of this invention will become apparent from the following description with reference to the accompanying drawings.

### BRIEF DESCRIPTION OF THE DRAWINGS

FIG. 1 is a circuit diagram of a power distribution/synthesis apparatus according to a first embodiment of the present invention;

FIG. 2A and FIG. 2B are views showing S parameters of the power distribution/synthesis apparatus shown in FIG. 1;

FIG. 3 is a circuit diagram of a power distribution/synthesis apparatus according to a second embodiment of the present invention;

FIG. 4A and FIG. 4B are views showing S parameters of the power distribution/synthesis apparatus shown in FIG. 3;

FIG. 5 is a circuit diagram of a power distribution/synthesis apparatus according to a third embodiment of the present invention;

FIG. 6 is a circuit diagram of one example of a power distribution/synthesis apparatus based on the conventional technology;

FIG. 7A and FIG. 7B are views showing S parameters of the power distribution/synthesis apparatus shown in FIG. 6;

FIG. 8 is a circuit diagram of another example of the power distribution/synthesis apparatus based on the conventional technology; and

FIG. 9A and FIG. 9B are views showing S parameters of the power distribution/synthesis apparatus shown in FIG. 8.

### DESCRIPTION OF THE PREFERRED EMBODIMENTS

Preferred embodiments of the power distribution/synthesis apparatus according to the present invention are described in detail below in the order of outline of the present invention, and first to third embodiments with reference to the attached drawings.

Outline of the Present Invention

In the power distribution/synthesis apparatus according to the present invention, a transmission line of length L and having the characteristic impedance of √2·Z0 is provided between an absorption resistor and each of second of I/O terminals and further between each quarter wavelength line and the second I/O terminal corresponding to the quarter wavelength line. Therefore, sufficient space can be insured between I/O terminals and isolation between the I/O terminals linked to each other via an absorption resistor can be kept at high level.

In the Wilkinson type of power distribution/synthesis apparatus, each of the quarter wavelength lines matches the impedance between the I/O terminals, and at the same time plays a role of controlling a phase difference between the lines. More specifically, when a phase difference between the following two paths:

1. I/O terminal→Absorption resistor→I/O terminal,

2. I/O terminal→Quarter wavelength line→Branch section→Quarter wavelength line→I/O terminal is a half wavelength, high-frequency signals passing through the paths respectively can cancel each other out, which makes isolation between the I/O terminals high. Accordingly, even if a line is added between an absorption resistor and an output terminal, a phase difference of a half wavelength between the half wavelength lines can be insured by adding a transmission line with the same length as that of the line between the I/O terminal and the quarter wavelength line.

The characteristic impedance of the added line herein is set line equivalent to that of the quarter wavelength line. Therefore, unnecessary reflection can be suppressed.

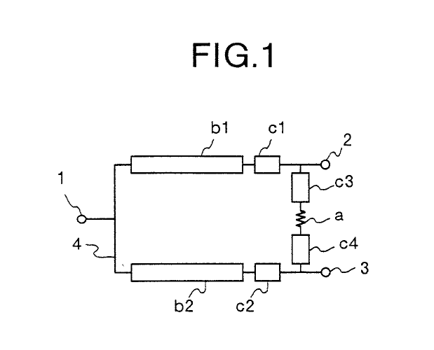

FIG. 1 is a circuit diagram of a power distribution/synthesis apparatus according to a first embodiment of the present invention. In this figure, designated at the reference numerals 1, 2, and 3 are I/O terminals, at 4 a branch section, at a an absorption resistor, at b1 and b2 quarter wavelength lines. Transmission lines c1 to c4, each having a power length of 20 degrees, are added based on the present invention.

Two-quarter wavelength lines b1 and b2 are connected to the I/O terminal 1 via the branch section 4. The transmission line c1 is connected to the other end of the quarter wavelength line b1, and the other end of this transmission line c1 is connected to the I/O terminal 2. The transmission line c2 is connected to the other end of the quarter wavelength line b2, and the other end of this transmission line c2 is connected to the I/O terminal 3.

The transmission line c3 is connected to one end of the absorption resistor a, and the transmission line c4 is connected to the other end thereof.

The other end of the transmission line c3 is connected to the I/O terminal 2, and the other end of the transmission line c4 is connected to the I/O terminal 3. As described above, the I/O terminals 2 and 3 are connected to each other via the transmission line c3, absorption resistor a, and transmission line c4. The characteristic impedance of each of the quarter wavelength lines b1, b2 and transmission lines c1 to c4 is √2·Z0.

The operation in the above-described configuration is explained below. A signal applied from the I/O terminal 1 is distributed into the quarter wavelength line b1 and the transmission line c1 as well as into the quarter wavelength line b2 and the transmission line c2 in a uniform amplitude via the branch section 4, and the distributed signals are fetched from the I/O terminals 2 and 3. Each of the quarter wavelength lines b1 and b2 operates as an impedance converter and matches a characteristic impedance Z0 the I/O terminal 1 to that of each external circuit connected to the I/O terminal 2 and I/O terminal 3. The absorption resistor a absorbs unbalanced components of the I/O terminals 2 and 3 and thus provides an isolation between the I/O terminal 2 and the I/O terminal 3.

As described above, by providing the transmission line c3 between the absorption resistor a and the I/O terminal 2 and the transmission line c4 between the absorption resistor a and the I/O terminal 3, crosstalk can be suppressed. In addition, by providing the transmission line c1 between the quarter wavelength line b1 and the I/O terminal 2 and the transmission line c2 between the quarter wavelength line b2 and the I/O terminal 3, high-frequency signals passing through the paths described below respectively cancel each other out, which also allows isolation between the I/O terminals 2 and 3 to highly be insured.

1. I/O terminal 2→Absorption resistor a I/O terminal 3,

2. I/O terminal 2→Quarter wavelength line b1→Branch section 4 Quarter wavelength line b2→I/O terminal 3.

Dimensions in this embodiment designed with a micro-strip line formed on a polyimide film with a characteristic impedance of each I/O terminal of 50 Ω, a frequency of 25 GHz, a thickness of 100 μm, and inductivity of 3.5 are as follows: each of quarter wavelength lines b1 and b2 has a characteristic impedance of 70.71 Ω, width 0.124 mm, and length 1.835 mm; and each of the transmission lines c1 to c4 has a characteristic impedance of 70.71 Ω, width 0.124 mm, and length 0.408 mm.

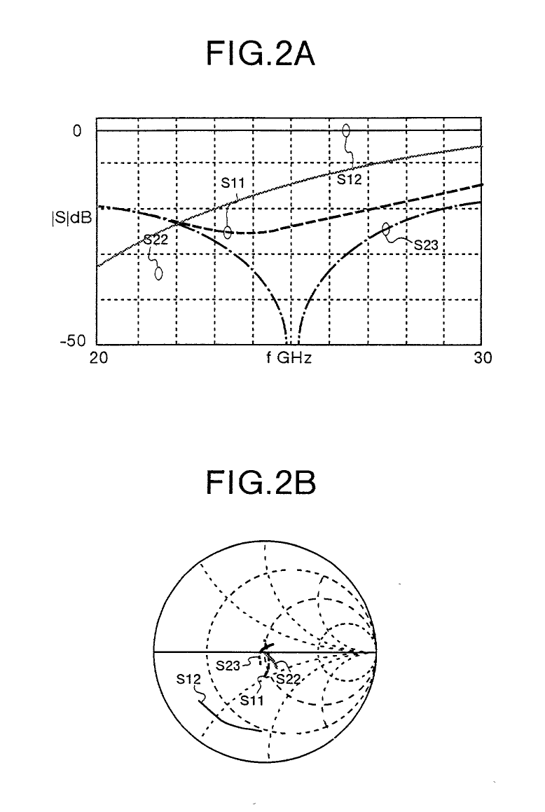

The S parameters in this case are shown in FIG. 2A and FIG. 2B. FIG. 2A is shown in dB, and FIG. 2B shows a Smith chart. The isolation between the I/O terminals 2 and 3 indicated by a line S23 is zero at the design frequency of 25 GHz, which shows that complete isolation is achieved therebetween.

As described above, in the power distribution/synthesis apparatus according to the first embodiment described above, by providing the transmission line c1 of length L and characteristic impedance √2·Z0 between the quarter wavelength line b1 and the I/O terminal 2, the transmission line c2 of length L and characteristic impedance √2·Z0 between the quarter wavelength line b2 and the I/O terminal 3, the transmission line c3 of length L and characteristic impedance √2·Z0 between the absorption resistor a and the I/O terminal 2, and further by providing the transmission line c4 of length L and characteristic impedance √2·Z0 between the absorption resistor a and the I/O terminal 3, crosstalk can be suppressed, space between I/O terminals can sufficiently be insured and isolation between the I/O terminals can be kept at a high level.

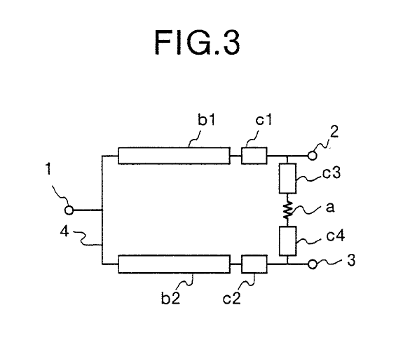

FIG. 3 is a circuit diagram of a power distribution/synthesis apparatus according to a second embodiment of the present invention. In this figure, designated at the reference numerals 1, 2, and 3 are I/O terminals, at 4 a branch section, at a an absorption resistor, at b1 and b2 quarter wavelength lines. Transmission lines c1 to c4, each having a power length of 180 degrees, are added according to the present invention. The configuration is the same as that of the power distribution/synthesis apparatus according to the first embodiment except the power length of the transmission lines c1 to c4 is different therefrom, so that description thereof is omitted here.

Dimensions in the embodiment designed with a micro-strip line formed on a polyimide film with a characteristic impedance of each I/O terminal of 50 Ω, a frequency of 25 GHz, a thickness of 100 μm, and inductivity of 3.5 are as follows: each of quarter wavelength lines b1 and b2 has a characteristic impedance of 70.71 Ω, width 0.124 mm, and length 5.505 mm; and each of the transmission lines c1 to c4 has a characteristic impedance of 70.71 Ω, width 0.124 mm, and length 3.67 mm.

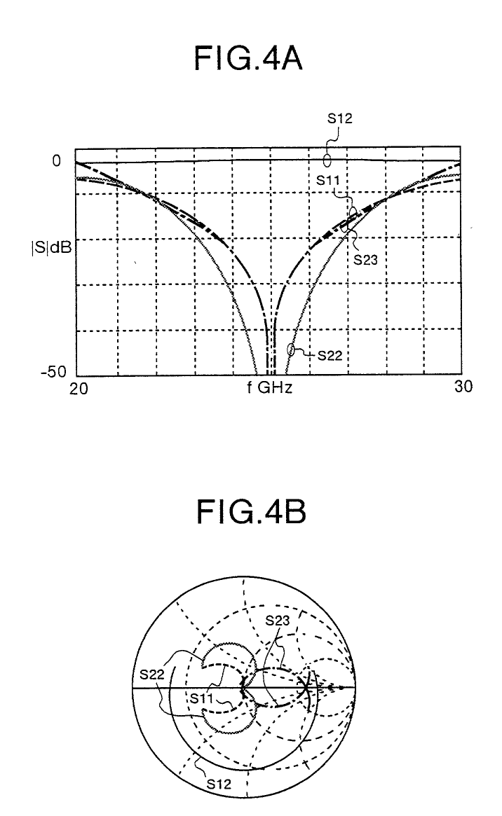

The S parameters in this case are shown in FIG. 4A and FIG. 4B. FIG. 4A is shown in dB, and FIG. 4B shows a Smith chart. The amount of a reflection of each I/O terminal indicated by lines S11 and S12 and isolation between the I/O terminals 2 and 3 indicated by line S23 are zero at the design frequency of 25 GHz, which shows that a complete matching and isolation are achieved therebetween.

As described above, in the power distribution/synthesis apparatus according to the second embodiment described above, by providing the transmission line c1 of half wavelength between the quarter wavelength line b1 and the I/O terminal 2, the transmission line c2 of half wavelength between the quarter wavelength line b2 and the I/O terminal 3, the transmission line c3 of half wavelength between the absorption resistor a and the I/O terminal 2, and further by providing the transmission line c4 of half wavelength between the absorption resistor a and the I/O terminal 3, matching among all of the components can completely be performed. In addition, crosstalk can be suppressed, space between I/O terminals can sufficiently be insured and isolation between the I/O terminals kept at high level.

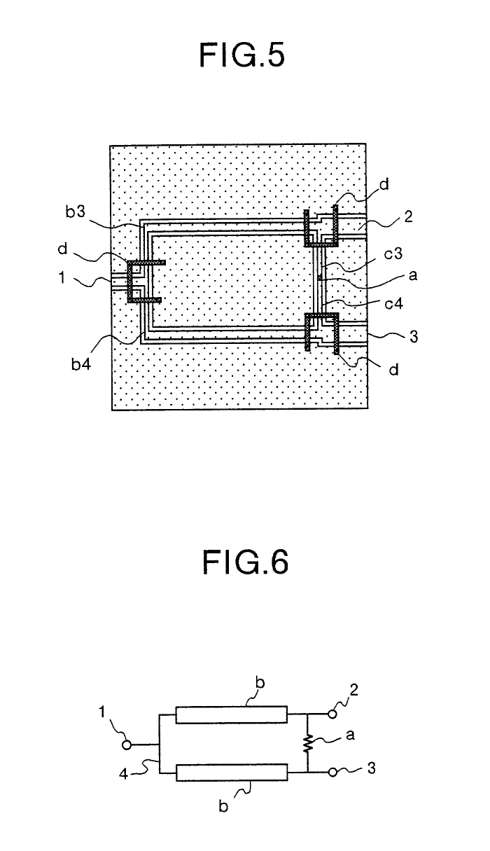

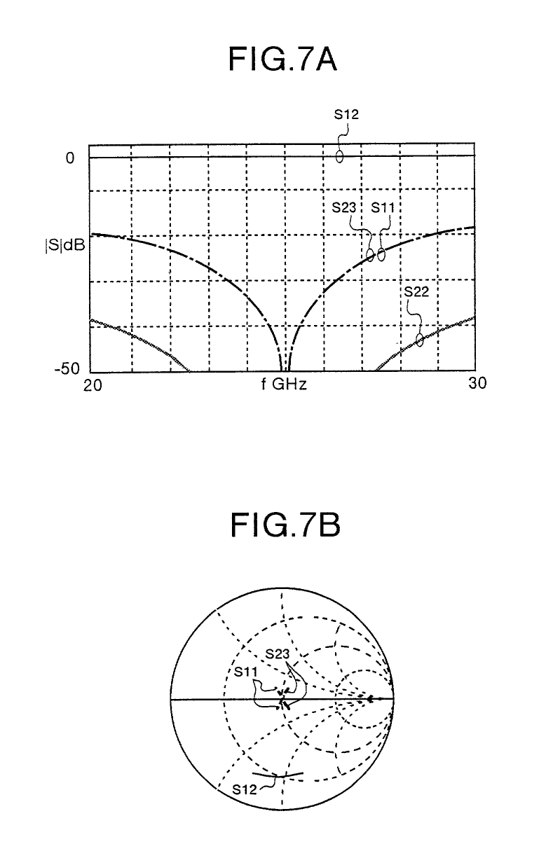

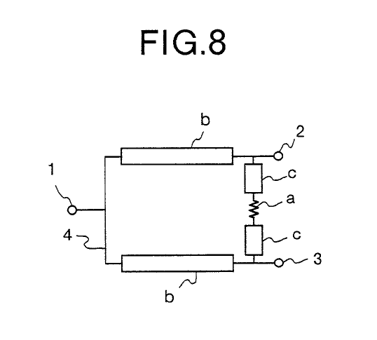

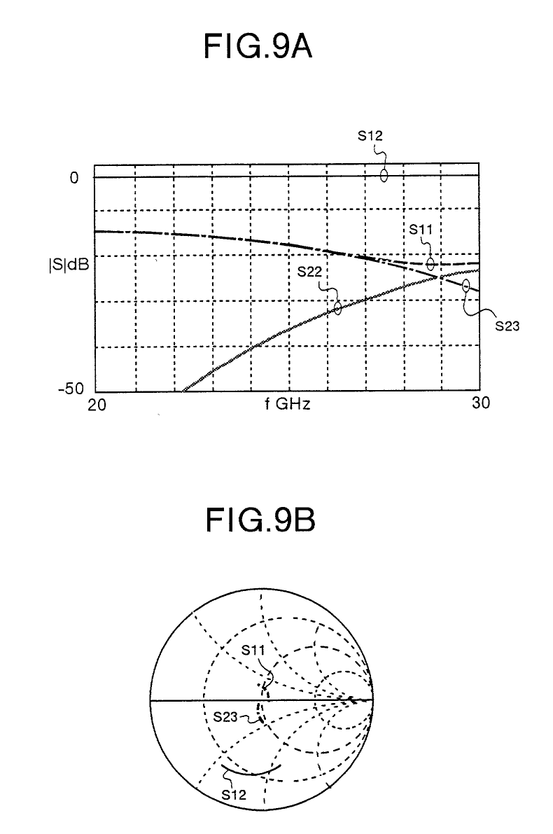

FIG. 5 is a circuit diagram of a power distribution/synthesis apparatus according to a third embodiment of the present invention. In this figure, designated at the reference numerals 1, 2, and 3 are I/O terminals, at a an absorption resistor, at b3 and b4 quarter wavelength lines. Transmission lines c3 and c4, each having a power length of 20 degrees (a total power length is 110 degrees), added according to the present invention, and at dan air bridge.

Dimensions in the embodiment designed with a CPW formed on a polyimide film with a characteristic impedance of each I/O terminal of 50 Ω, a frequency of 25 GHz, a thickness of 100 μm, and inductivity of 3.5 are as follows: each of lines b3 and b4 has a characteristic impedance of 70.71 Ω, width of the central conductor 0.029 mm, gap width 0.01 mm, and length 2.436 mm; and each of the transmission lines c3 and c4 has a characteristic impedance of 70.71 Ω, width of the central conductor 0.029 mm, gap width 0.01 mm, and length 0.443 mm.

As described above, the power distribution/synthesis apparatus according to the third embodiment is a complicated circuit including air bridges. However, a layout with a sufficient space between the output terminals 2 and 3 can be insured by providing the transmission lines c3 and c4 therein.

The present invention is not limited to the embodiments described above, and can be constructed by embodying all modifications and alternative constructions that may occur to one skilled in the art which fairly fall within the basic teaching herein set forth. For example, the present invention is applicable to a power distribution/synthesis apparatus using N units of I/O terminals for one I/O terminal. In this case, a characteristic impedance of the quarter wavelength lines and the transmission lines of length L will be √N·Z0.

In addition, even if the absorption resistor can not be made sufficiently smaller because of the necessity to use a large electric power, a completely-matched power distribution/synthesis apparatus can easily be produced by designing a transmission line through addition of a change rate in a phase in the absorption resistor to a quarter wavelength line.

As described above, the present invention provides a transmission line of length L and characteristic impedance √2·Z0 between the absorption resistor and each of the second I/O terminals and further between each of quarter wavelength lines and the second I/O terminal corresponding to the quarter wavelength line. Therefore, it is possible to suppress crosstalk, provide a sufficient space between the I/O terminals and thus keep the isolation therebetween at a high level.

Further, transmission lines of length L set to a half wavelength or an integral multiple of the half wavelength are provided between the absorption resistor and each of the second I/O terminals and further between each of the quarter wavelength lines and the second I/O terminal corresponding to the quarter wavelength line. Therefore, it is possible to completely perform all the matching, suppress crosstalk, provide a sufficient space between the I/O terminals and thus keep the isolation therebetween at a high level.

Further, the circuit is formed with a CPW. Therefore, it is possible to obtain a power distribution/synthesis apparatus in which there is a high degree of flexibility in its layout and can easily be connected to a semiconductor device.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A Wilkinson type of power distribution/synthesis apparatus, in which the characteristic impedance of the I/O terminals is Z0, said apparatus comprising:
a first I/O terminal;
two quarter wavelength lines one terminal of each of which is connected to the first I/O terminal, has a characteristic impedance of √2·Z0, and function as two second I/O terminals;
an absorption resistor connected between the remaining terminal of said quarter wavelength lines;
a transmission line of a length L such that the characteristic impedance will be √2·Z0 is provided between said absorption resistor and one of said second I/O terminals;
a transmission line of a length L such that the characteristic impedance will be √2·Z0 is provided between said absorption resistor and other of said second I/O terminals;
a transmission line of a length L such that the characteristic impedance will be √2·Z0 is provided between one of said quarter wavelength lines and one of said second I/O terminals; and
a transmission line of a length L such that the characteristic impedance will be √2·Z0 is provided between other of said quarter wavelength lines and other of said second I/O terminals.

2. The power distribution/synthesis apparatus according to claim 1; wherein the length L of said transmission lines is equal to half wavelength or an integral multiple of half wavelength.

3. The power distribution/synthesis apparatus according to claim 1; wherein each of said transmission lines provided in this circuit are formed with CPW (Co-Planar Waveguide).

4. The power distribution/synthesis apparatus according to claim 2; wherein each of said transmission lines provided in this circuit are formed with CPW (Co-Planar Waveguide).
